(19) United States
(12) Patent Application Publication
(10) Pub. No.: US 2011/0198952 A1
(43) Pub. Date: Aug. 18, 2011

(54) BRUSHLESS DC MOTOR

(76) Inventors: Manabu Nakamura, Kitasaku-gun (JP); Yuzuru Suzuki, Kitasaku-gun (JP)

(21) Appl. No.: 13/026,755

(22) Filed: Feb. 14, 2011

(30) Foreign Application Priority Data
Feb. 15, 2010 (JP) 2010-029669

(51) Int. Cl. H02K 5/22

(52) U.S. Cl. 310/71

(57) ABSTRACT

A brushless DC motor includes a housing having an upper and a lower housings, a stator including a stator core and a coil wound around the stator core, a rotor rotatably disposed in the stator, an annular terminal block disposed at an axial side of the stator and having an axially protruding terminal connected to an end of the coil, a disc-shaped substrate holding the annular terminal block with the stator and having a sensor IC and a driving circuit, the substrate provided with a fitting portion closely fitted by the terminal, wherein the terminal of the terminal block is closely fitted into the fitting portion of the substrate and the end of the coil is electronically connected to the substrate via a portion in which the end of the coil is connected to the terminal.

### RELATED APPLICATIONS

This application claims priority under 35 U.S.C. §119 to Japanese Patent Application No. 2010-029669 filed on Feb. 15, 2010, the entire content of which is hereby incorporated by reference.

### BACKGROUND OF THE INVENTION

1. Field of the Invention

The present invention relates to a brushless DC motor provided with a coil having an end portion with a specific connecting structure.

2. Related Art

Some kinds of brushless DC motors, in which a disc-shaped substrate having a sensor IC and a driving circuit is provided on an axial one side surface of a stator wound with a coil, are known. In this structure, a method for connecting an end of a coil wound around a terminal of an insulator to the substrate is complicated, and positioning of the substrate with respect to the stator and the sensor IC is required. Furthermore, after the winding operation, the end of the coil must be connected to a part of the substrate, whereby many operating steps are required in assembling.

Relating to the above technique, Japanese Patent Application, First Publication No. 2001-245455 discloses a motor in which a cylindrical receiver for a control substrate mounted to a stator is provided. In the structure, plural protruding ribs for positioning and engaging the control substrate and plural protruding ribs in which the end portions thereof are abutting around a circumferential surface of the control substrate and receiving the control substrate are formed on a circumferential surface of the cylindrical receiver in the vicinity of an edge thereof. Furthermore, slits for temporary engaging ends of a coil of the stator are formed on the abutting surfaces of the ribs which receive the control substrate in such a way that the positions of the slits coincide with the terminals for connecting the coil of the control substrate.

Japanese Patent Application, First Publication No. 2007-143295 discloses a structure in which a radial protrusion is formed on a substrate having a driving circuit and a sensor circuit, whereby the coil wound around a stator is connected to the protrusion. In the structure, the protrusion is partially connected to the coil and the unconnected portion thereof absorbs thermal stress, so that disconnection of the coil can be avoided.

### SUMMARY OF THE INVENTION

According to conventional methods, the connecting structure of the end of the coil wound around the terminal with respect to the substrate is complicated. Furthermore, the end of the coil must be connected to a part of the substrate after the winding operation, whereby many operating steps are required. For example, according to a technique disclosed by Japanese Patent Application, First Publication No. 2001-245455, the coil must be subjected to temporary engaging and removing therefrom, and must be connected to the substrate, so that many operating steps and parts are required.

According to the technique disclosed by Japanese Patent Application, First Publication No. 2007-143295, a protrusion of the substrate is radially protruding, so that the winding operation of the coil around a stator and the winding operation of the end of the coil around the protrusion of the substrate cannot be sequentially performed in an assembling step, and must be performed in individual steps. The reason for this is that, in the above condition, a small Brush DC motor is restricted to have a radially sufficient space and the radial protrusion which can be automatically wound with the coil cannot be easily formed.

In view of the above background of the technique, an object of the present invention is to provide a brushless DC motor in which the winding operation can be easily performed and assembling steps can be reduced compared to conventional techniques.

According to a first aspect of the present invention, the brushless DC motor includes a housing having an upper and a lower housings, a stator including a stator core and a coil wound around the stator core, a rotor rotatably disposed in the stator, an annular terminal block disposed in an axial side of the stator and provided with an axially protruding terminal connected to an end of the coil, a disc-shaped substrate holding the annular terminal block with the stator and provided with a sensor IC and a driving circuit, the substrate provided with a fitting portion closely fitted by the terminal wherein the terminal of the terminal block is closely fitted to the fitting portion of the substrate and the end of the coil is electronically connected to the substrate via a portion in which the end of the coil is connected to the terminal.

According to the first aspect of the present invention, since the terminal is axially protruding, even if the radial space in the structure is restricted, a winding operation with respect to the terminal by the autocontrolled winding apparatus can be easily performed. Therefore, the winding operation of the coil around the stator core and subsequent winding operation of the end of the coil around the terminal of the terminal block can be sequentially performed by an autocontrolled winding apparatus. Positioning of the end of the coil with respect to the terminal portion of the substrate can be completed by axially abutting the terminal block at the substrate and closely fitting of the terminal to the fitting portion of the substrate. Therefore, the end of the coil is easily connected to the substrate. Furthermore, the terminal bock is positioned with respect to the substrate by fitting the terminal of the terminal block to the fitting portion of the substrate, so that the substrate can be easily positioned. Thus, the winding operation in the present invention can be easily performed compared to conventional techniques and a brushless DC motor having reduced producing steps can be obtained.

According to a second aspect of the present invention, the terminal block has an axial protrusion closely fitted into a recessed portion formed on the axially circumferential surface of the stator. According to the second aspect, the protrusion of the terminal block is fitted into the recessed portion of the stator core, so that the stator core is positioned with respect to the terminal block. Therefore, positioning between the sensor IC on the substrate and the stator core can be performed without a special jig.

According to a third aspect of the present invention, the terminal block is made from an insulating material and is integrally molded with the terminal.

According to a fourth aspect of the present invention, in one of the first to the third aspects, the terminal block has a recessed portion in the periphery of the terminal thereof, whereby the coil is connected easily.

According to a fifth aspect of the present invention, in one of the first to the fourth aspects, an end portion of the terminal of the terminal block closely fitted into the substrate is not connected by the coil.

According to a sixth aspect of the present invention, axial dimension of the terminal block except for axial dimensions of the terminal axially formed thereon and the axial protrusion therefrom is defined as “A”, axial dimension of the coil wound around the stator core is defined as “B”, and axial dimension of the stator core is defined as “C”, and “A”, “B”, and “C” satisfy the following formula.

A>(B−C)/2

According to a seventh aspect of the present invention, in one of the first to the sixth aspects, the substrate is provided with a land on the surface facing to the terminal block in the periphery of the fitting portion, whereby the end of the coil which is wound around the terminal is connected to the land via an electrical connection. According to the seventh aspect of the embodiment, the end of the coil connected to the terminal is electrically connected to the land by, for example, soldering or reflowing.

According to the first aspect of the present invention, the brushless DC motor in which the winding operation can be easily performed and assembling steps can be reduced compared to the conventional technique.

According to the second aspect of the present invention, positioning of the substrate with respect to the stator core can be easily performed by closely fitting of the protrusion of the terminal block to the recessed portion of the stator core.

According to the third aspect of the present invention, integrally molded parts are applied, so that the cost of the parts and production thereof can be reduced.

According to the fourth aspect of the present invention, stable winding of the end of the coil and the winding operation by the autocontrolled winding apparatus can be easily performed by using the recessed portion.

According to the fifth aspect of the present invention, the terminal can be accurately fitted into the fitting portion.

According to the sixth aspect of the present invention, the stator can be axially positioned by determining thickness of the terminal block.

According to the seventh aspect of the present invention, electrical connecting of the coil to the substrate can be accurately and reliably performed by using the land.

### BRIEF DESCRIPTION OF THE DRAWINGS

FIG. 1 is a cross-sectional view of a brushless DC motor in accordance with an embodiment of the present invention.

FIG. 2 is a schematic and exploded view of a structure including a stator in accordance with the embodiment of the present invention.

FIG. 3 is schematic and exploded view of the structure including the stator in accordance with the embodiment of the present invention.

FIG. 4 is a schematic and exploded view of the structure including the stator in accordance with the embodiment of the present invention.

FIG. 5 is a partial side view of a portion around a terminal viewed from a radially outward direction in accordance with the embodiment of the present invention.

FIG. 6 is a partially enlarged view of FIG. 5 in accordance with the embodiment of the present invention.

### DETAILED DESCRIPTION OF THE PREFERRED EMBODIMENTS

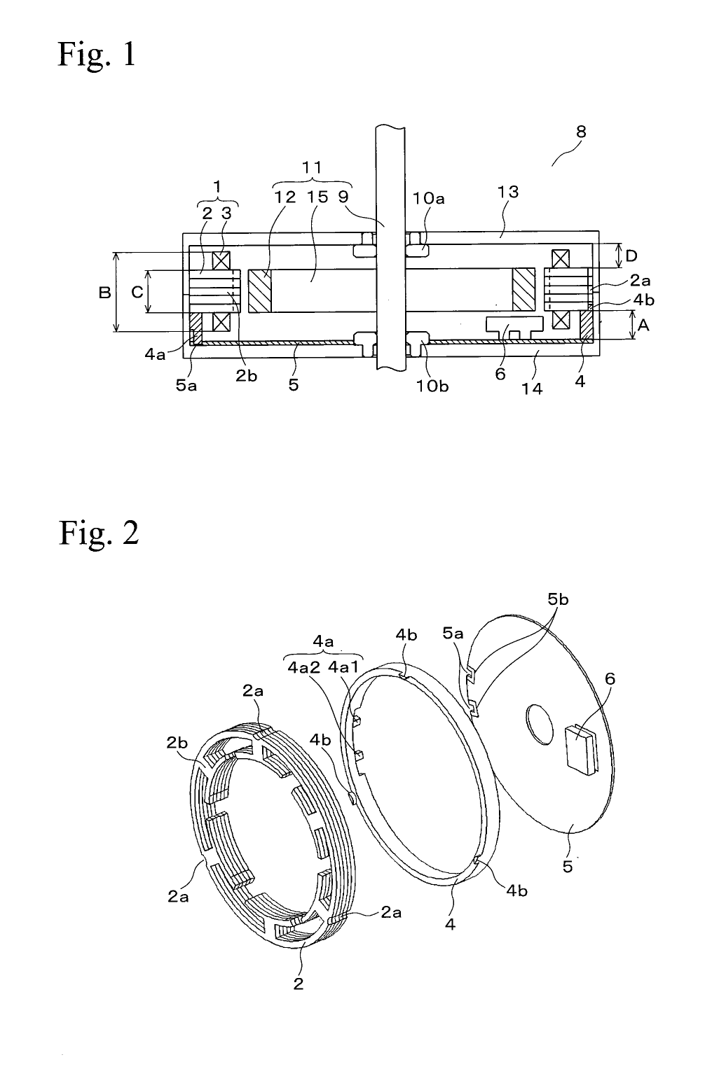

FIG. 1 is a cross-sectional view of a brushless DC motor in accordance with an embodiment of the present invention. The brushless DC motor 8 in accordance with the embodiment is shown in FIG. 1. The brushless DC motor 8 is provided with a shaft 9. A holding member 15 having a disc-shaped structure is fixed to the shaft 9, and a circumferential portion thereof is multiply magnetized, whereby a permanent magnet 12 used as a rotor magnet is formed. A rotor 11 is composed of the shaft 9, the holding member 15 and the permanent magnet 12.

The shaft 9 of the rotor 11 is rotatably held with respect to an upper housing 13 by a bearing 10a and is rotatably held with respect to a lower housing 14 by a bearing 10b. By this structure, the rotor 11 is rotatable with respect to the upper housing 13 and the lower housing 14.

The upper housing 13 and the lower housing 14 are integrally fixed to each other and form a housing of the brushless DC motor. A stator core 2 is held in the inside of the housing composed of the upper housing 13 and the lower housing 14. The stator core 2 is provided with six pole teeth 2b disposed at an equal angle interval and each pole tooth 2b is wound with a coil 3 working as a stator coil. The permanent magnet 12 of the rotor 11 is faced to the inner circumferential surfaces of the pole tooth 2b of the stator 1 with a gap and the rotor 11 is rotatably disposed in the stator 1.

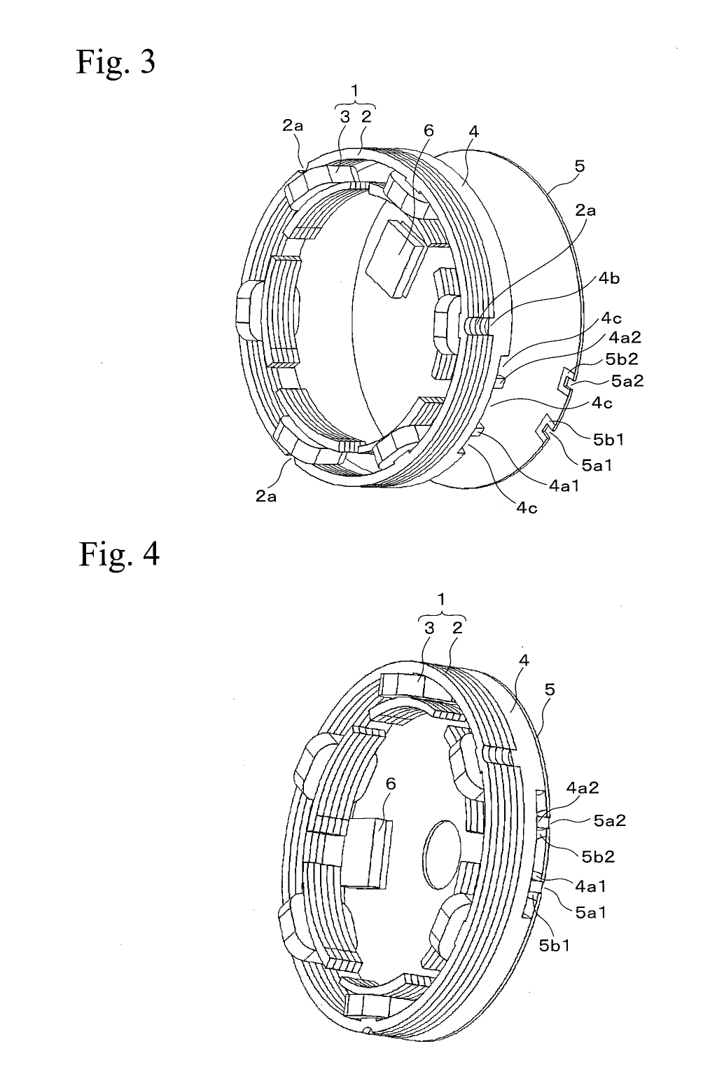

FIGS. 2 to 4 are schematic views of a portion including the stator 1. FIG. 2 shows the structure in a condition in which the stator core 2, a terminal block 4 and a disc-shaped substrate 5 are separated from each other. The structure in a condition in which only the substrate 5 is separated from other components is shown in FIG. 3, and the structure in a condition in which the stator 2, the terminal block 4 and the substrate 5 are coupled to each other is shown in FIG. 4. The structure in a condition in which the stator core 2 is wound with the coil 3 is shown in FIGS. 3 and 4.

As shown in FIGS. 2 to 4, the stator core 2 is to the terminal block 4 having a substantially annular structure and the terminal block 4 is connected to the disc-shaped substrate 5. The terminal block 4 having a substantially annular structure is made of an insulating material and has a positioning protrusion 4b which is axially protruding toward the stator core 2. A positioning recessed portion 2a which is fitted by the positioning protrusion 4b is formed on an outer circumferential surface of the stator core 2. The stator core 2 is connected to the terminal block 4 in a condition in which the positioning protrusion 4b is closely fitted into the positioning recessed portion 2a, so that the terminal block 4 and the stator 1 are connected to each other in a condition in which mutual positioning thereof is performed.

The terminal block 4 is provided with a terminal 4a (4a1 and 4a2) axially protruding toward the substrate 5. The terminal 4a is integrally molded with the terminal block 4. The peripheral portions of the terminals 4a1 and 4a2 are axially notched, whereby the protruding lengths thereof are added with lengths of the notched portions.

The substrate 5 is a substantially disc-shaped electronic substrate in which a through hole penetrated by the shaft 9 is formed at the center thereof. A sensor IC 6 for detecting angular positions of the rotor 11 and a driving circuit (not shown) for supplying a driving current to the coil 3 are provided on the surface of the substrate 5. A notched portion 5a (5a1 and 5a2) to closely fit with the terminal 4a (4a1 and 4a2) is provided on an edge portion of the substrate 5. The notched portion 5a (5a1 and 5a2) is one example of the portion closely fitted by the terminal 4a. A land 5b (5b1 and 5b2) composed of a conductive pattern is provided at the periphery of the edge of the notched portion 5a (5a1 and 5a2) on the surface of the substrate 5. The land 5b is connected to the circuit pattern on the substrate 5.

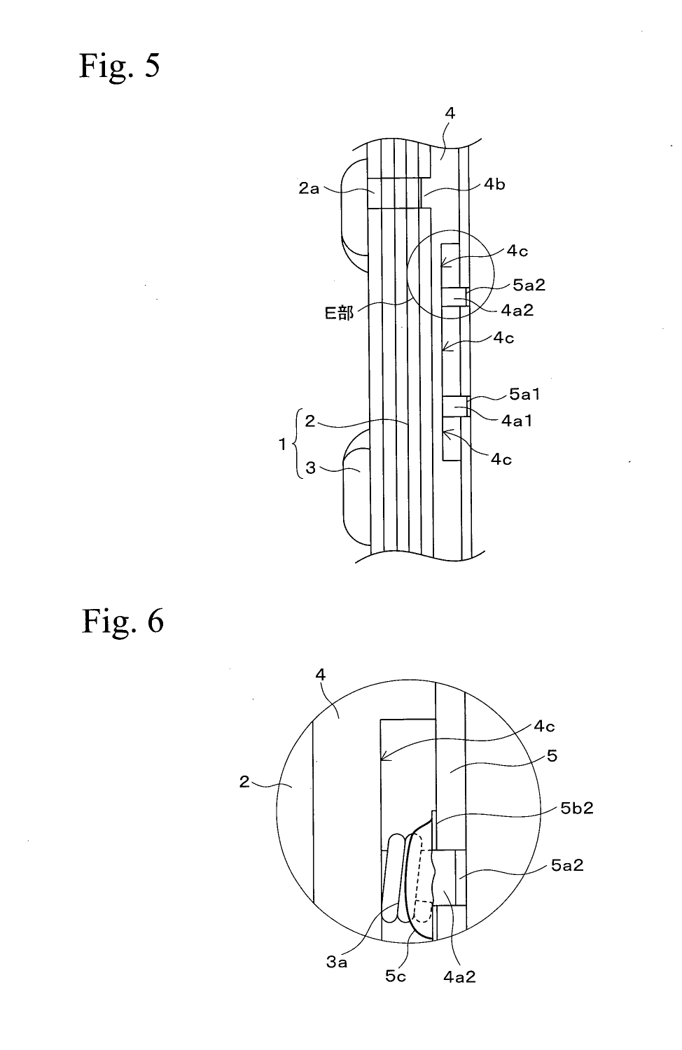

FIG. 5 shows a partial side view of a portion in a vicinity of a terminal viewed from a radially outward direction. FIG. 6 shows an enlarged view of the portion E in FIG. 5. As shown in FIG. 6, a coiled portion 3a is an end of the coil 3 (see FIG. 4) and is wound around the base portion of the terminal 4a2. An end portion of the terminal 4a2 is protruded from the coiled portion 3a so as to be fitted into the notched portion 5a2 of the substrate 5. The coiled portion 3a is abutted at the land 5b2 provided at the periphery of the notched portion 5a2 of the substrate 5, whereby the coiled portion 3a is electrically connected to the land 5b2 via an electrical connection 5c, which is formed, for example, by soldering or reflowing. The structure of the terminal 4a1 is the same as the structure of the terminal 4a2. By the above structure, the substrate 5 is electrically connected to the coil 3 via the terminal block 4.

As shown in FIG. 1, the axial dimension and the position of the stator 1 are determined so that the coil 3 wound around the stator core 2 is not abutted at the substrate 5 and the upper housing 13. Specifically, the axial dimension of the terminal block 4 except for axial sizes of the terminal 4a axially formed thereon and the axial positioning protrusion 4b is defined as “A”, axial dimension of the coil 3 wound around the stator core 2 is defined as “B” and axial dimension of the stator core 2 is defined as “C”, and “A”,“B”, and “C” satisfy the following formula.

A>(B−C)/2

Furthermore, axial distance between an inner surface of the upper housing 13 and an upper surface of the stator core 2 is defined “D”, and “D” satisfies the following formula.

D>(B−C)/2

Since the values A to D satisfy the above formulas, the stator 1 is axially positioned by the axial dimension (height) A of the terminal block 4 and the coil 3 wound around the stator core 2 is not abutted at the substrate 5 and the upper housing 13.

An example of assembling the structure of the stator is explained hereinafter. First, in the condition shown in FIG. 2, the protrusion 4b for positioning of the terminal block 4 is fitted into the recessed portion 2a for positioning of the stator core 2, so that the terminal block 4 is positioned with respect to the stator core 2, whereby both members are fixed. The above fixing, for example, may be performed by an adhesive.

The six pole teeth 2b are wound with a wire and six coils 3 are provided. The terminal 4a1 is wound with an end of the wire at the base thereof before forming the coil 3 and the terminal 4a2 is wound with another end of the wire at the base thereof after forming the coil 3. This operation is performed by an autocontrolled winding apparatus. The above condition of the structure is shown in FIG. 3.

The terminals 4a1 and 4a2 of the terminal block 4 are positioned at the notched portions 5a1 and 5a2 of the substrate 5, whereby the terminals 4a1 and 4a2 are fitted thereto. In this operation, the coiled portion 3a is abutted at the land 5b2 (see FIG. 6). In this condition, an electrical connection 5c shown in FIG. 6 is formed in such a way as soldering or reflowing, so that the coiled portion 3a is electronically connected to the land 5b2. A coiled portion (not shown) of the terminal 4a1 is also electronically connected to the land 5b1 in the same way. It should be noted that the terminal block 4 is fixed to the substrate 5 by an adhesive. Thus, the condition of the structure shown in FIG. 4 is obtained.

As above mentioned, the brushless DC motor of the embodiment, as shown in FIG. 1, is provided with the stator 1 including the stator core 2 having the pole tooth 2b on the inner circumferential surface thereof and the coil 3 wound around the pole tooth 2b. As shown in FIGS. 3 and 4, the annular terminal block 4 disposed in the axial exterior of the stator 1 and having the axially protruding terminals 4a1 and 4a2 connected to the ends of the coil 3 is provided to the brushless DC motor. Furthermore, the disc-shaped substrate 5 holding the terminal block 4 with the stator 1 and having the sensor IC 6 and the driving circuit, and the notched portions 5a1 and 5a2 formed at the circumferential portion thereof is also provided to the brushless DC motor. In this structure, the terminals 4a1 and 4a2 of the terminal block 4 are closely fitted into the notched portions 5a1 and 5a2, and the ends of the coil 3 (for example, the coiled portion 3a in FIG. 6) connected to the terminals 4a1 and 4a2 are electronically connected to the substrate 5 via the electrical connection 5c formed, for example, by soldering or reflowing.

According to the above structure, by using the terminals 4a1 and 4a2, treatment of the end portions of the coil 3, electronically connecting of the coil 3 to the substrate 5, and positioning of the substrate 5 with respect to the terminal block 4 are performed. Therefore, assembling steps thereof can be reduced. Furthermore, since the terminals 4a1 and 4a2 are axially protruding, sufficient protruding length of the terminals can be obtained in a limited space and the working operation for winding by an autocontrolled winding apparatus can be easily performed. Therefore, winding operation can be easily performed compared to the conventional technique.

That is, the terminals 4a1 and 4a2 are fitted into the notched portions 5a1 and 5a2, as typically shown in FIG. 6, so that the coiled portion 3a is contacted to (or come into proximity with) the land 5b2 and is positioned with respect to the land 5b2. In this condition, the connecting operation of the end of the coil 3 with respect to the substrate 5 can be easily performed. More specifically, since the end of the coil 3 (the coiled portion 3a) is positioned with respect to the terminal (the land 5b) of the substrate by mounting the substrate 5 to the terminal block 4, and after this operation, the electrical connection 5c is formed by the soldering or reflowing, whereby the end of the coil 3 is fixed to the terminal of the substrate 5, and thus, the connecting the end of the coil 3 to the substrate 5 is completed. Since the end of the coil 3 is also positioned with respect to the substrate 5 by connecting the terminal block 4 to the substrate 5, the assembling operation can be simplified. Furthermore, in the embodiment, inferior connecting of the wires can be reduced compared to the assembling in which the coils are individually connected to the substrate.

As shown in FIG. 2, the terminal block 4 has the positioning protrusion 4b which is axially protruding and closely fitted into the positioning recessed portion 2a formed on the axially circumferential surface of the stator core 2. According to this structure, the terminal block 4 has not only the function of the terminal 4a, but also the function in which the stator 1 and the substrate 5 can be positioned with respect to each other without a special jig. As a result, the assembling steps thereof can be simplified. The IC sensor 6 used for detecting angle of the rotating position of the rotor 11 can also be positioned with respect to the rotor 11 without a special jig.

The terminal block 4 is integrally molded with the terminal 4a and is made from the insulating material. In this structure, cost of parts and production cost can be reduced, and high accuracy in the structure of the terminal 4a as a member for positioning can be obtained.

As shown in FIGS. 5 and 6, the terminal block 4 has a recessed portion 4c at the periphery of the terminal 4a2, whereby the space for coiled portion 3a, which is the connected portion of the coil 3, is formed. In this structure, a reliable structure can be obtained and easy winding by the auto-controlled winding apparatus can be performed.

As typically shown in FIG. 6, the end portion of the terminal 4a2 closely fitted into the substrate 5 (fitted into the notched portion 5a2) is not wound with the end of the coil 3 and is not coiled portion 3a. Therefore, the end portion of the terminal 4a2 is protruded therefrom and can be securely fitted into the notched portion 5a2. Furthermore, since the coiled portion 3a is not fitted into the notched portion 5a2, the notched portion 5a2 may not be too large, high accuracy in positioning the terminal 4a2 with respect to the substrate 5 can be obtained.

As shown in FIG. 1, axial dimension of the terminal block 4 except for axial dimensions of the terminal 4a axially formed thereon and the axial positioning protrusion 4b is defined as “A”, axial dimension of the coil 3 wound around the stator core 2 is defined as “B”, and axial dimension of the stator core 2 is defined as “C”, and “A”, “B”, and “C” satisfy the following formula.

A>1/2(B−C)

In this structure, the stator 1 can be axially positioned by the terminal block 4 without the special jig, whereby the assembling steps thereof can be simplified.

As shown in FIG. 3, in the structure of substrate 5, the lands 5b1 and 5b2 are formed at the periphery of the notched portions 5a1 and 5a2 which are formed on the surface facing to the terminal block 4. In this structure, as exemplified in FIG. 6, the coiled portion 3a can be electrically connected to the electronic circuit of the substrate 5 via the electrical connection 5c formed, for example, by soldering or reflowing instead of a connecting operation with complicated wiring.

It should be noted that the notched portion 5a may simply be a recessed portion fitted by the terminals 4a1 and 4a2. Therefore, the notched portion with a bottom, an opening portion with a bottom or an opening portion without a bottom may be applied instead of the notched portion 5a. The above condition of the structure may also be applied to the structure of the positioning recessed portion 2a. The present invention is not limited to the above embodiments and includes variations obvious to those skilled in the art, and effects of the invention are not restricted by the above embodiments. That is, various additions, modifications, and partial omissions are possible within the scope of the concept and the objects of the invention, as claimed and equivalents thereof.

The present invention may be used for brushless DC motors.

What is claimed is:

1. A brushless DC motor comprising:
a housing having an upper housing and a lower housing;
a stator including, a stator core having a plurality of pole teeth extending radially and inwardly from an inner surface thereof, a coil wound around the pole teeth;
a rotor rotatably disposed in the stator;
an annular terminal block disposed at an axial side of the stator and having an axially protruding terminal connected to an end of the coil; and
a disc-shaped substrate holding the annular terminal block with the stator and having a sensor IC and a driving circuit, the substrate provided with a fitting portion closely fitted by the terminal;
wherein the terminal of the terminal block is closely fitted into the fitting portion of the substrate and the end of the coil is electronically connected to a substrate via a portion in which the end of the coil is connected to the terminal.

2. A brushless DC motor according to claim 1, wherein the terminal block has an axially protruding portion fitted into a recessed portion axially formed on a surface of the stator core.

3. A brushless DC motor according to claim 1, wherein the terminal block is made of an insulating material and is integrally molded with the terminal.

4. A brushless DC motor according to claim 1, wherein the terminal block is provided with a recessed portion in the vicinity of the terminal, and the recessed portion is used for a space for connecting the coil.

5. A brushless DC motor according to claim 1, wherein an end portion of the terminal of the terminal block fitted into the substrate is not connected to the coil.

6. A brushless DC motor according to claim 2, wherein an axial dimension of the terminal block except for axial dimensions of the terminal and the axial protrusion is defined as “A”, an axially dimension of the coil wound around the stator core is defined as “B”, and an axial dimension of the stator core is defined as “C”, and “A”, “B”, and “C” satisfy the following formula.
A>(B−C)/2

7. A brushless DC motor according to claim 6, wherein an axial distance between an inner surface of the upper housing and an upper surface of the stator core is defined as “D”, and “D” satisfies the following formula.
D>(B−C)/2

8. A brushless DC motor according to of claim 1, wherein the substrate is provided with a land on the surface thereof facing the terminal block around the fitting portion and a connected portion of the end of the coil to the terminal is connected to the land via an electrically connected portion.
